(19) United States
(12) Patent Application Publication
(10) Pub. No.: US 2023/0259581 A1
(43) Pub. Date: Aug. 17, 2023

(54) METHOD AND APPARATUS FOR FLOATING-POINT DATA TYPE MATRIX MULTIPLICATION BASED ON OUTER PRODUCT

(71) Applicant: ELECTRONICS AND TELECOMMUNICATIONS RESEARCH INSTITUTE, Daejeon (KR)

(72) Inventors: Won JEON, Daejeon (KR); Young-Su KWON, Daejeon (KR); Ju-Yeob KIM, Daejeon (KR); Hyun-Mi KIM, Daejeon (KR); Hye-Ji KIM, Daejeon (KR); Chun-Gi LYUH, Daejeon (KR); Mi-Young LEE, Daejeon (KR); Jae-Hoon CHUNG, Daejeon (KR); Yong-Cheol CHO, Daejeon (KR); Jin-Ho HAN, Daejeon (KR)

(73) Assignee: ELECTRONICS AND TELECOMMUNICATIONS RESEARCH INSTITUTE, Daejeon (KR)

(21) Appl. No.: 18/109,690

(22) Filed: Feb. 14, 2023

(30) Foreign Application Priority Data
Feb. 15, 2022 (KR) 10-2022-0019574
Jan. 4, 2023 (KR) 10-2023-0001234

(51) Int. Cl. G06F 17/16; G06F 5/01

(52) U.S. Cl. CPC G06F 17/16; G06F 5/012

(57) ABSTRACT

Disclosed herein is a method for outer-product-based matrix multiplication for a floating-point data type includes receiving first floating-point data and second floating-point data and performing matrix multiplication on the first floating-point data and the second floating-point data, and the result value of the matrix multiplication is calculated based on the suboperation result values of floating-point units.

### CROSS REFERENCE TO RELATED APPLICATIONS

This application claims the benefit of Korean Patent Applications No. 10-2022-0019574, filed Feb. 15, 2022, and No. 10-2023-0001234, filed Jan. 4, 2023, which are hereby incorporated by reference in their entireties into this application.

### BACKGROUND OF THE INVENTION

### 1. Technical Field

The present disclosure relates to a method for hardware design and operation of a floating-point unit that may greatly increase resource utilization, compared to an existing structure, when outer-product-based matrix multiplication, which is used for various applications such as an artificial neural network, and the like, is performed.

### 2. Description of the Related Art

Applications based on an artificial neural network or a deep-learning model generally perform operations on values stored in the form of a vector or a matrix for images, voice, pattern data, and the like.

Particularly, because each piece of data is in the form of a decimal floating-point number, the operation performance of floating-point matrix multiplication greatly affects the performance of an artificial neural network application. Particularly, operations using small floating-point data types, such as a 16-bit and 8-bit floating-point formats, rather than an existing 32-bit floating-point format, are widely used for recent artificial neural networks.

However, a currently used floating-point unit has a problem in that efficiency is decreased because it has a part that cannot be used for parallel operations.

### DOCUMENTS OF RELATED ART

(Patent Document 1) Korean Patent Application Publication No. 10-2019-0119074, titled “Widening arithmetic in a data processing apparatus”.

### SUMMARY OF THE INVENTION

An object of the present disclosure is to apply an outer-product-based matrix multiplication method to floating-point matrix multiplication, which used in various fields, such as artificial neural network operations, and the like, thereby improving operation efficiency.

Another object of the present disclosure is to provide a multi-format floating-point operation structure that is capable of upper-level operation using multiple lower-level operators.

In order to accomplish the above objects, a method for outer-product-based matrix multiplication for a floating-point data type according to an embodiment of the present disclosure includes receiving first floating-point data and second floating-point data and performing matrix multiplication on the first floating-point data and the second floating-point data, and the result value of the matrix multiplication is calculated based on the suboperation result values of respective floating-point units.

Here, the suboperation result values may correspond to intermediate result values of an outer product of the first floating-point data and the second floating-point data.

Here, the first floating-point data and the second floating-point data may be divided into sizes capable of being input to the floating-point units and may then be input to the respective floating-point units.

Here, performing the matrix multiplication may comprise performing a shift operation and an addition operation on the suboperation result value of each of the floating-point units.

Here, each of the first floating-point data and the second floating-point data may be divided into upper bits and lower bits.

Here, performing the matrix multiplication may comprise performing a shift operation, corresponding to double the size of the lower bits, on the result value of a suboperation performed on the upper bits of the first floating-point data and the upper bits of the second floating-point data.

Here, performing the matrix multiplication may comprise performing a shift operation, corresponding to the size of the lower bits, on the result value of a suboperation performed on the upper bits of the first floating-point data and the lower bits of the second floating-point data and on the result value of a suboperation performed on the lower bits of the first floating-point data and the upper bits of the second floating-point data.

Also, in order to accomplish the above objects, an apparatus for outer-product-based matrix multiplication for a floating-point data type according to an embodiment of the present disclosure includes an input unit for receiving first floating-point data and second floating-point data and an operation unit for performing matrix multiplication on the first floating-point data and the second floating-point data, and the operation unit includes suboperation units for calculating suboperation result values for the result value of the matrix multiplication.

Here, the suboperation result values may correspond to intermediate result values of an outer product of the first floating-point data and the second floating-point data.

Here, the first floating-point data and the second floating-point data may be divided into sizes capable of being input to the suboperation units and may then be input to the respective suboperation units.

Here, the operation unit may perform a shift operation and an addition operation on the suboperation result value of each of the suboperation units.

Here, each of the first floating-point data and the second floating-point data may be divided into upper bits and lower bits.

Here, the operation unit may perform a shift operation, corresponding to double the size of the lower bits, on the result value of a suboperation performed on the upper bits of the first floating-point data and the upper bits of the second floating-point data.

Here, the operation unit may perform a shift operation, corresponding to the size of the lower bits, on the result value of a suboperation performed on the upper bits of the first floating-point data and the lower bits of the second floating-point data and on the result value of a suboperation performed on the lower bits of the first floating-point data and the upper bits of the second floating-point data.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is a view conceptually illustrating a method for performing matrix multiplication;

FIG. 2 illustrates the structure of a floating-point unit for performing parallel operations for various data types;

FIG. 3 is a flowchart illustrating a method for outer-product-based matrix multiplication for a floating-point data type according to an embodiment of the present disclosure;

FIG. 4 illustrates the structure of a floating-point unit for parallel multi-format matrix operations according to an embodiment of the present disclosure;

FIG. 5 illustrates that upper bits are divided for a multi-format operation method according to an embodiment of the present disclosure;

FIG. 6 is a block diagram illustrating an apparatus for outer-product-based matrix multiplication for a floating-point data type according to an embodiment of the present disclosure; and

FIG. 7 is a view illustrating the configuration of a computer system according to an embodiment.

### DESCRIPTION OF THE PREFERRED EMBODIMENTS

The advantages and features of the present disclosure and methods of achieving the same will be apparent from the exemplary embodiments to be described below in more detail with reference to the accompanying drawings. However, it should be noted that the present disclosure is not limited to the following exemplary embodiments, and may be implemented in various forms. Accordingly, the exemplary embodiments are provided only to disclose the present disclosure and to let those skilled in the art know the category of the present disclosure, and the present disclosure is to be defined based only on the claims. The same reference numerals or the same reference designators denote the same elements throughout the specification.

It will be understood that, although the terms “first,” “second,” etc. may be used herein to describe various elements, these elements are not intended to be limited by these terms. These terms are only used to distinguish one element from another element. For example, a first element discussed below could be referred to as a second element without departing from the technical spirit of the present disclosure.

The terms used herein are for the purpose of describing particular embodiments only, and are not intended to limit the present disclosure. As used herein, the singular forms are intended to include the plural forms as well, unless the context clearly indicates otherwise. It will be further understood that the terms “comprises,” “comprising,”, “includes” and/or “including,” when used herein, specify the presence of stated features, integers, steps, operations, elements, and/or components, but do not preclude the presence or addition of one or more other features, integers, steps, operations, elements, components, and/or groups thereof.

In the present specification, each of expressions such as “A or B”, “at least one of A and B”, “at least one of A or B”, “A, B, or C”, “at least one of A, B, and C”, and “at least one of A, B, or C” may include any one of the items listed in the expression or all possible combinations thereof.

Unless differently defined, all terms used herein, including technical or scientific terms, have the same meanings as terms generally understood by those skilled in the art to which the present disclosure pertains. Terms identical to those defined in generally used dictionaries should be interpreted as having meanings identical to contextual meanings of the related art, and are not to be interpreted as having ideal or excessively formal meanings unless they are definitively defined in the present specification.

Hereinafter, embodiments of the present disclosure will be described in detail with reference to the accompanying drawings. In the following description of the present disclosure, the same reference numerals are used to designate the same or similar elements throughout the drawings, and repeated descriptions of the same components will be omitted.

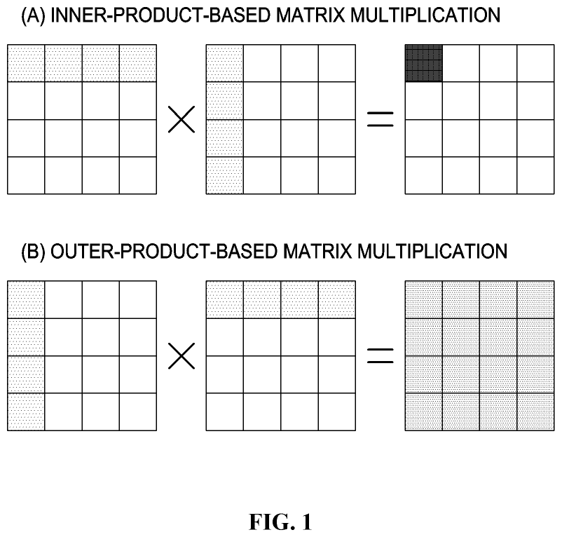

FIG. 1 is a view conceptually illustrating a method for matrix multiplication.

In order to complete the multiplication of two matrices, multiple multiplication and addition operations should be performed.

As a method for performing the multiplication of two matrices, there are a method of using an inner product as shown in (a) of FIG. 1 and a method of using an outer product as shown in (b) of FIG. 1. In the case of the method using an inner product, the final value of each element of a result matrix is calculated through one operation step, and in the case of the method using an outer product, partial sums are calculated for all of the elements of a result matrix. The two methods have the same matrix multiplication result when the final operation step is finished.

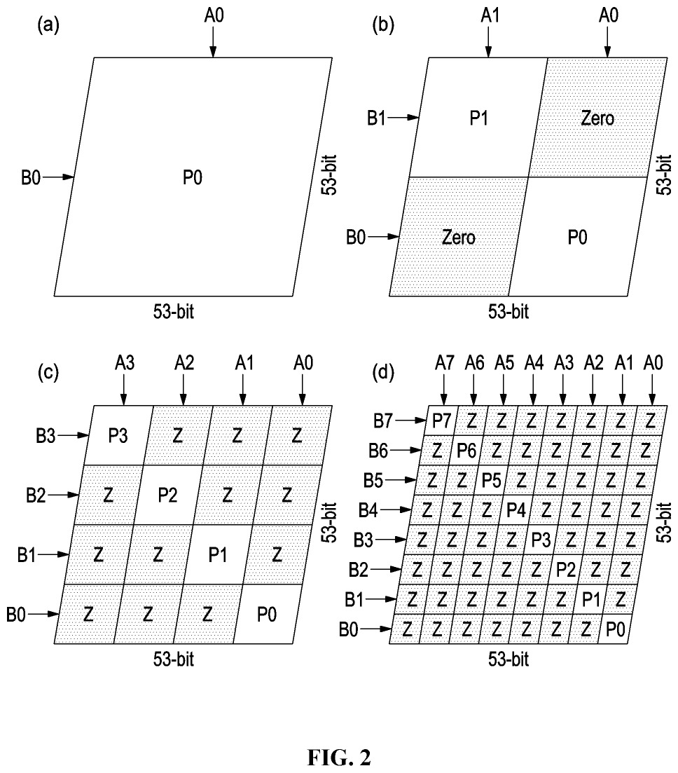

FIG. 2 illustrates the structure of a floating-point unit for performing parallel operations for various data types.

A floating-point unit (FPU) is a hardware structure for performing various operations, including arithmetic operations, on floating-point data, which is used to represent real numbers using a binary system, in a computer system. In order to support efficient parallel operations for various floating-point data types (e.g., FP64, FP32, FP16, BF16, and FP8), many structures capable of processing multiple pieces of small data in parallel using an FPU for a single large data type have been proposed (a multiformat vector FPU).

FIG. 2 illustrates the structure of a multiformat vector FPU that is capable of simultaneously performing parallel operations on two pieces of FP32 data (P0 and P1), four pieces of FP16 data (P0 to P3), or eight pieces of FP8 data (P0 to P7) using a single FP64 FPU multiplier. However, the proposed structure has a problem in that the hardware resource utilization of the operator is decreased because zeros (Z) are input to the part that cannot be used for parallel operations.

Accordingly, technology for designing new FPU hardware capable of increasing the utilization of a hardware resource, which is more wasted as the data type for which a floating-point operation is performed is smaller, and more efficiently processing floating-point matrix multiplication for various data types is required.

The most basic FPU requires separate FPU hardware components for respective data types in order to perform operations on different types of floating-point data. The conventional technology (a multiformat vector FPU), which is more advanced than the existing FPU, enables operations on various types of floating-point data using a single shared hardware component and supports parallel operations on small-sized data types. However, an underutilized hardware resource is still present in the conventional technology, and the utilization of the hardware resource may be improved by changing the existing vector operation structure into a matrix operation structure, whereby parallel floating-point operation performance per hardware area may be improved.

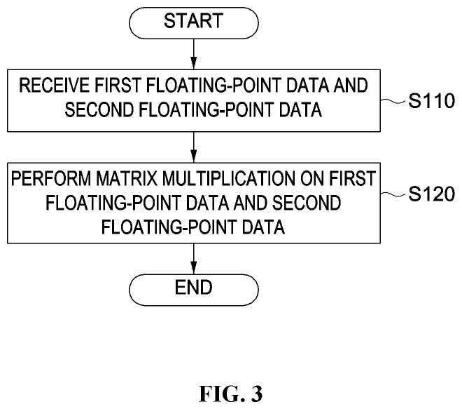

FIG. 3 is a flowchart illustrating a method for outer-product-based matrix multiplication for a floating-point data type according to an embodiment of the present disclosure.

Referring to FIG. 3, a method for outer-product-based matrix multiplication for a floating-point data type according to an embodiment of the present disclosure includes receiving first floating-point data and second floating-point data at step S110 and performing matrix multiplication on the first floating-point data and the second floating-point data at step S120, and the result value of the matrix multiplication is calculated based on the suboperation results of respective floating-point units.

Here, the suboperation result value may correspond to the intermediate result value of the outer product of the first floating-point data and the second floating-point data.

Here, each of the first floating-point data and the second floating-point data may be input to each of the floating-point units after being divided into sizes capable of being input to the floating-point unit.

Here, at the step (S120) of performing the matrix multiplication, shift and addition operations may be performed on the suboperation result of each of the floating-point units.

Here, each of the first floating-point data and the second floating-point data may be divided into upper bits and lower bits.

Here, at the step (S120) of performing the matrix multiplication, a shift operation corresponding to double the size of the lower bits may be performed on the result value of the suboperation performed on the upper bits of the first floating-point data and the upper bits of the second floating-point data.

Here, at the step (S120) of preforming the matrix multiplication, a shift operation corresponding to the size of the lower bits may be performed on the result value of the suboperation performed on the upper bits of the first floating-point data and the lower bits of the second floating-point data and on the result value of the suboperation performed on the lower bits of the first floating-point data and the upper bits of the second floating-point data.

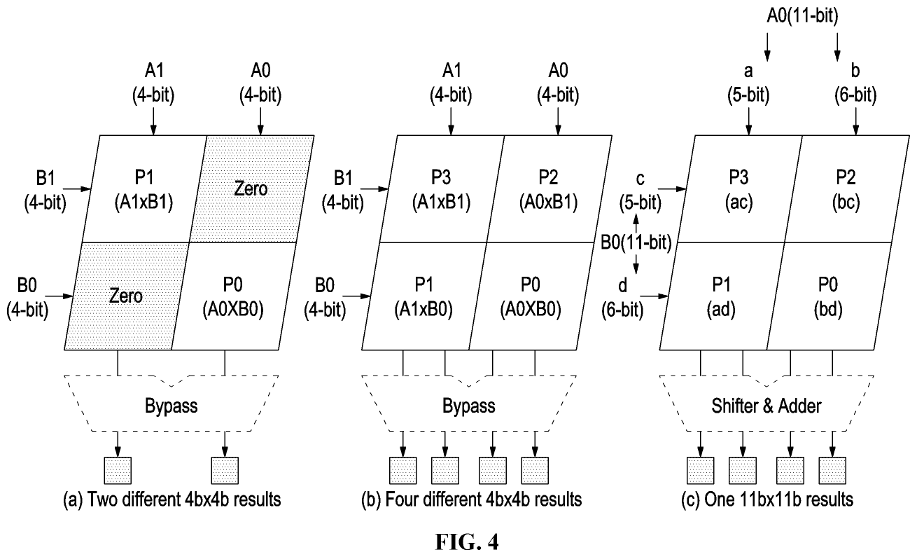

FIG. 4 illustrates the structure of a floating-point unit for parallel multi-format matrix operations according to an embodiment of the present disclosure.

Referring to FIG. 4, it can be seen that the schematic diagram and the operation method (b, c) of the hardware structure of a multi-format matrix FPU proposed by the present disclosure are compared with those of the existing structure (a). Particularly, (a) and (b) illustrate an example in which an operation is performed on two FP8 data input groups, and (c) illustrates an example in which an operation is performed on one FP16 data input group. Here, FP8 data is configured with one sign bit, four exponent bits, and three mantissa bits, and FP16 data is configured with one sign bit, five exponent bits, and ten mantissa bits.

Because the proposed structure is capable of processing four FP8 multiplication operations at once or processing one FP16 multiplication operation using the hardware resource of a single shared multiplier, resource utilization and parallel operation performance may be improved, compared to an existing FPU, which is capable of processing two FP8 multiplication operations at once or processing one FP16 multiplication operation.

Referring to (b) of FIG. 4, the multiplication results 1 and 2 (P1 and P2) are not operation results pursued by a user in a general vector-type operation, because element-wise vector multiplication in the form of [A1, A0]×[B1, B0] uses only the results of P0 and P3. However, in outer-product-based matrix multiplication shown in (b) of FIG. 1, both P1 and P2 are intermediate results that are essential for matrix multiplication, and correspond to essential multiplication operations. Accordingly, in the proposed matrix-type FPU structure, the part that is unused in the existing vector-type FPU by being filled with zeros may be used for P1 and P2 operations.

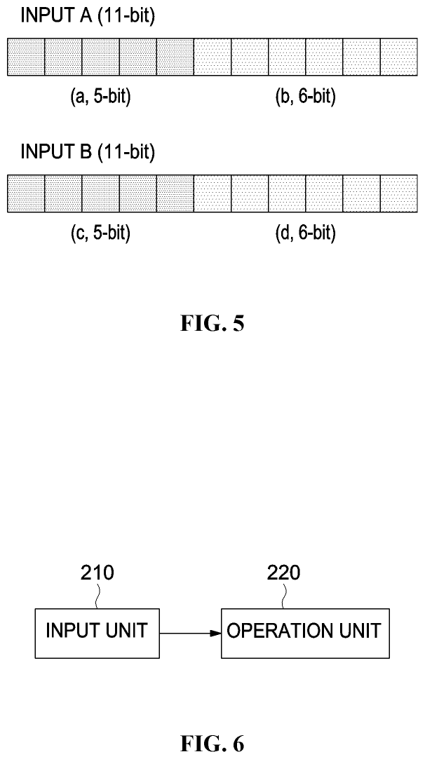

FIG. 5 illustrates that upper bits are divided for a multi-format operation method according to an embodiment of the present disclosure.

According to an embodiment of the present disclosure, four small operators may be collectively used as a single large operator in order to improve the utilization of an FPU hardware resource, which is underutilized in the conventional FPU, and to support multi-format floating-point operations. In (c) of FIG. 4, an example in which four FP8 operators operate as a single FP16 operator is illustrated. When the operators operate in (c) mode, each of P0 to P3 computes the intermediate result of a partial sum for an FP16 operation result, rather than computing a single independent FP8 operation result. Here, ac, bc, ad, and bd in (c) may correspond to the intermediate results for the result of multiplication of A and B, which are FP16 inputs shown in FIG. 4. Using a shifter and an adder, bit-shift and addition operations are performed on the four multiplication results, whereby an FP16 mantissa operation may be performed.

In the example illustrated in FIG. 5, the bit-shift and addition operations may be performed as follows.

A=(a<<6+b)

B=(c<<6+d)

A×B=(a<<6+b)×(c<<6+d)=ac<<12+ad<<6+bc<<6+bd

That is, matrix multiplication may be performed using four multiplication operations, three bit-shift operations, and three addition operations.

Also, the proposed FPU structure may be recursively applied to multiple floating-point data formats. That is, like the four FP8 operators combined into a single FP16 operator, four FP16 operators may be combined into a single FP32 operator, and four FP32 operators may be combined into a single FP64 operator.

Consequently, when the proposed hardware design method is applied, a single FP64 operator may perform a single FP64 operation, four FP32 operations, 16 FP16 operations, or 64 FP8 operations at once. Accordingly, the resource sharing utilization of FPU hardware and parallel operation ability per hardware area for small floating-point data types, such as FP16 and FP8, may be improved.

This FPU hardware structure may be used in semiconductors such as an AI processor and the like for accelerating an artificial neural network application in which matrix multiplication capability is important and particularly in which many matrix multiplication operations using small floating-point data types, such as FP16, FP8, and the like, are used.

FIG. 6 is a block diagram illustrating an apparatus for outer-product-based matrix multiplication for a floating-point data type according to an embodiment of the present disclosure.

Referring to FIG. 6, the apparatus for outer-product-based matrix multiplication for a floating-point data type according to an embodiment of the present disclosure includes an input unit 210 to which first floating-point data and second floating-point data are input and an operation unit 220 for performing matrix multiplication on the first floating-point data and the second floating-point data, and the operation unit includes suboperation units for calculating suboperation result values for the result value of the matrix multiplication.

Here, the suboperation result value may correspond to the intermediate result value of the outer product of the first floating-point data and the second floating-point data.

Here, each of the first floating-point data and the second floating-point data may be input to each of the suboperation units after being divided into sizes capable of being input to the suboperation unit.

Here, the operation unit 220 may perform shift and addition operations on the suboperation result value of each of the suboperation units.

Here, each of the first floating-point data and the second floating-point data may be divided into upper bits and lower bits.

Here, the operation unit 220 may perform a shift operation corresponding to double the size of the lower bits on the result value of the suboperation performed on the upper bits of the first floating-point data and the upper bits of the second floating-point data.

Here, the operation unit 220 may perform a shift operation corresponding to the size of the lower bits on the result value of the suboperation performed on the upper bits of the first floating-point data and the lower bits of the second floating-point data and on the result value of the suboperation performed on the lower bits of the first floating-point data and the upper bits of the second floating-point data.

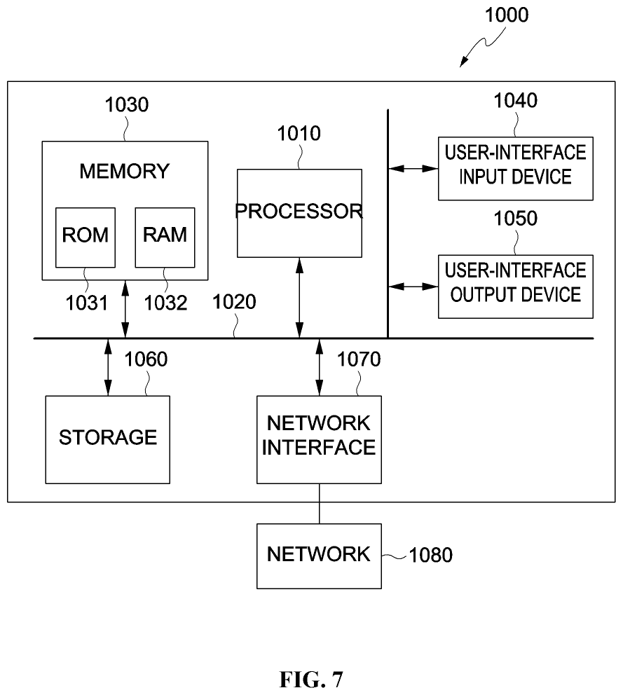

FIG. 7 is a view illustrating the configuration of a computer system according to an embodiment.

The apparatus for outer-product-based matrix multiplication for a floating-point data type according to an embodiment may be implemented in a computer system 1000 including a computer-readable recording medium.

The computer system 1000 may include one or more processors 1010, memory 1030, a user-interface input device 1040, a user-interface output device 1050, and storage 1060, which communicate with each other via a bus 1020. Also, the computer system 1000 may further include a network interface 1070 connected to a network 1080. The processor 1010 may be a central processing unit or a semiconductor device for executing a program or processing instructions stored in the memory 1030 or the storage 1060. The memory 1030 and the storage 1060 may be storage media including at least one of a volatile medium, a nonvolatile medium, a detachable medium, a non-detachable medium, a communication medium, or an information delivery medium, or a combination thereof. For example, the memory 1030 may include ROM 1031 or RAM 1032.

According to the present disclosure, an outer-product-based matrix multiplication method is applied to floating-point matrix multiplication, which is used in various fields, such as artificial neural network operations, and the like, whereby operation efficiency may be improved.

Also, the present disclosure may provide a multi-format floating-point operation structure that is capable of upper-level operation using multiple lower-level operators.

Specific implementations described in the present disclosure are embodiments and are not intended to limit the scope of the present disclosure. For conciseness of the specification, descriptions of conventional electronic components, control systems, software, and other functional aspects thereof may be omitted. Also, lines connecting components or connecting members illustrated in the drawings show functional connections and/or physical or circuit connections, and may be represented as various functional connections, physical connections, or circuit connections that are capable of replacing or being added to an actual device. Also, unless specific terms, such as “essential”, “important”, or the like, are used, the corresponding components may not be absolutely necessary.

Accordingly, the spirit of the present disclosure should not be construed as being limited to the above-described embodiments, and the entire scope of the appended claims and their equivalents should be understood as defining the scope and spirit of the present disclosure.

What is claimed is:

1. A method for outer-product-based matrix multiplication for a floating-point data type, which is performed by multiple floating-point units, comprising:
receiving first floating-point data and second floating-point data; and
performing matrix multiplication on the first floating-point data and the second floating-point data,
wherein
a result value of the matrix multiplication is calculated based on suboperation result values of the respective floating-point units.

2. The method of claim 1, wherein the suboperation result values correspond to intermediate result values of an outer product of the first floating-point data and the second floating-point data.

3. The method of claim 2, wherein the first floating-point data and the second floating-point data are divided into sizes capable of being input to the floating-point units and are then input to the respective floating-point units.

4. The method of claim 3, wherein performing the matrix multiplication comprises performing a shift operation and an addition operation on the suboperation result value of each of the floating-point units.

5. The method of claim 4, wherein each of the first floating-point data and the second floating-point data is divided into upper bits and lower bits.

6. The method of claim 5, wherein performing the matrix multiplication comprises
performing a shift operation, corresponding to double a size of the lower bits, on a result value of a suboperation performed on the upper bits of the first floating-point data and the upper bits of the second floating-point data, and
performing a shift operation, corresponding to the size of the lower bits, on a result value of a suboperation performed on the upper bits of the first floating-point data and the lower bits of the second floating-point data and on a result value of a suboperation performed on the lower bits of the first floating-point data and the upper bits of the second floating-point data.

7. An apparatus for outer-product-based matrix multiplication for a floating-point data type, comprising:
an input unit for receiving first floating-point data and second floating-point data; and
an operation unit for performing matrix multiplication on the first floating-point data and the second floating-point data,
wherein
the operation unit includes suboperation units for calculating suboperation result values for a result value of the matrix multiplication.

8. The apparatus of claim 7, wherein the suboperation result values correspond to intermediate result values of an outer product of the first floating-point data and the second floating-point data.

9. The apparatus of claim 8, wherein the first floating-point data and the second floating-point data are divided into sizes capable of being input to the suboperation units and are then input to the respective suboperation units.

10. The apparatus of claim 9, wherein the operation unit performs a shift operation and an addition operation on the suboperation result value of each of the suboperation units.

11. The apparatus of claim 10, wherein each of the first floating-point data and the second floating-point data is divided into upper bits and lower bits.

12. The apparatus of claim 11, wherein the operation unit performs a shift operation, corresponding to double a size of the lower bits, on a result value of a suboperation performed on the upper bits of the first floating-point data and the upper bits of the second floating-point data and performs a shift operation, corresponding to the size of the lower bits, on a result value of a suboperation performed on the upper bits of the first floating-point data and the lower bits of the second floating-point data and on a result value of a suboperation performed on the lower bits of the first floating-point data and the upper bits of the second floating-point data.
